(19) United States
(12) Patent Application Publication
(10) Pub. No.: US 2014/0055966 A1
(43) Pub. Date: Feb. 27, 2014

(54) POSITIONING STRUCTURE FOR AUDIO VIDEO JACK

(71) Applicants: FIH (Hong Kong) Limited, Kowloon (HK); SHENZHEN FUTAIHONG PRECISION INDUSTRY CO., LTD., Shenzhen (CN)

(72) Inventors: ZHENG-PING TAN, Shenzhen (CN); YAO WANG, Shenzhen (CN); KUAN-HUNG CHEN, Shindian (TW)

(21) Appl. No.: 13/928,956

(22) Filed: Jun. 27, 2013

(30) Foreign Application Priority Data
Aug. 27, 2012 (CN) 2012103066694

(51) Int. Cl. H01R 13/64

(52) U.S. Cl. CPC H01R 13/64
USPC 361/759; 439/345; 361/752

(57) ABSTRACT

A positioning structure for an audio video (AV) jack includes a receiving portion and a connector. The receiving portion includes a base plate, two opposite sidewalls, and an end wall. The connector includes an insulating body and a plurality of elastic metal fingers. The insulating body is positioned snuggly among the base plate, the two opposite sidewalls, and the end wall.

### BACKGROUND

1. Technical Field

The present disclosure generally relates to jacks, particularly to a positioning structure for an audio video jack used in an electronic device.

2. Description of Related Art

Electronic devices, such as mobile phones, have an audio video jack (AV jack). The AV jack has a connector, which needs to be secured in a housing of the electronic device. The housing surrounds a receiving cavity for positioning the AV jack. However, the connector is not always securely held in the receiving cavity, so it can easily fall out of the housing.

Therefore, there is room for improvement within the art.

### BRIEF DESCRIPTION OF THE DRAWINGS

Many aspects of a positioning structure for an AV jack can be better understood with reference to the following drawings. The components in the drawings are not necessarily to scale, the emphasis instead being placed upon clearly illustrating the positioning structure for the AV jack. Moreover, in the drawings, like reference numerals designate corresponding parts throughout the several views.

FIG. 1 is an exploded, isometric view of a positioning structure for an AV jack according to an exemplary embodiment.

FIG. 2 is an enlarged view of an insulating body.

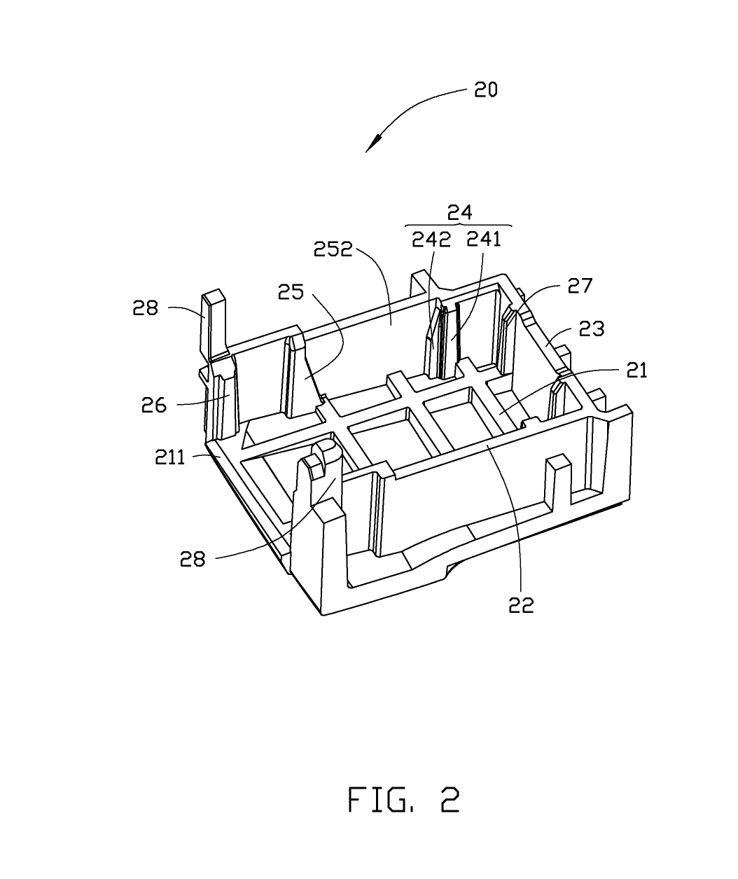

FIG. 3 is an assembled view of the positioning structure shown in FIG. 1.

FIG. 4 is an assembled view of the positioning structure installed in an electronic device.

### DETAILED DESCRIPTION

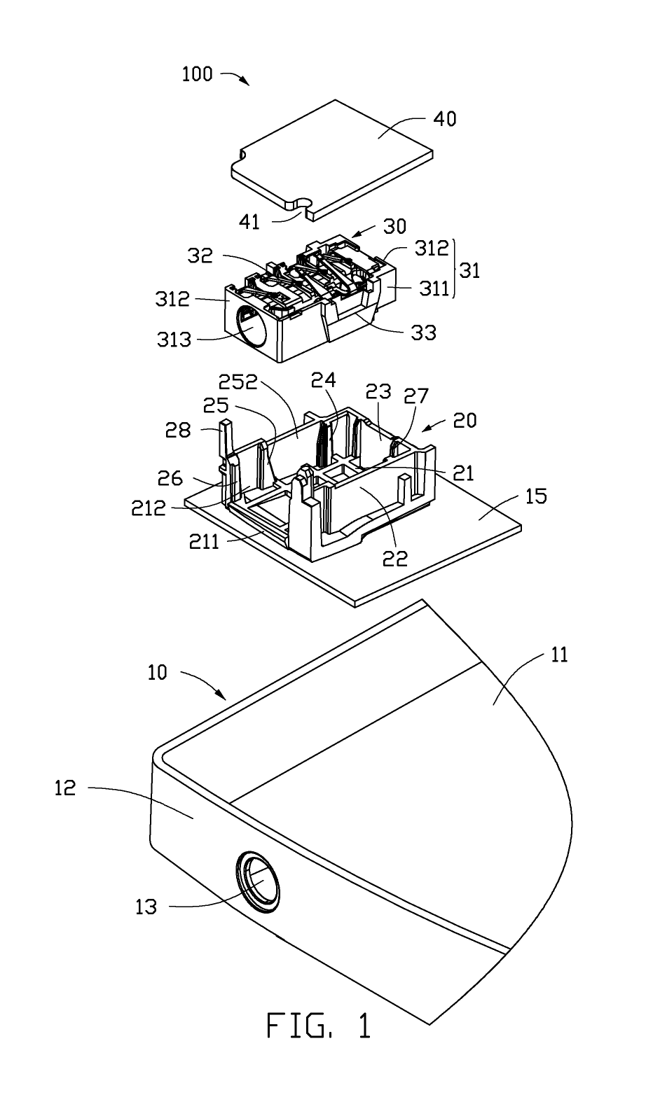

FIG. 1 shows a positioning structure for positioning an audio video jack (AV jack) in an electronic device 100 according to an exemplary embodiment. The positioning structure is installed in an electronic device 100, such as a mobile phone, to firmly secure the AV jack in the electronic device 100. The electronic device 100 includes a first housing 10 and a second housing 15.

The positioning structure comprises a receiving portion 20, a connector 30, and a printed circuit board (PCB) 40.

The first housing 10 surrounds the outside of the electronic device 100. In this exemplary embodiment, the first housing 10 is a battery cover. The first housing 10 has a main body 11 and a side plate 12 perpendicularly connected to the main body 11. The side plate 12 defines a through hole 13. The second housing 15 is positioned inside the electronic device 100 and engages with the first housing 10.

The receiving portion 20 is a part of the second housing 15. The receiving portion 20 comprises a base plate 21, two opposite sidewalls 22, and an end wall 23. The base plate 21 is substantially rectangular, and the two opposite sidewalls 22 are perpendicularly positioned at opposite sides of the base plate 21. The end wall 23 is positioned at a first end of the base plate 21. An opening 212 is defined in a second end of the base plate 21 and between the two sidewalls 22. A cushion portion 211 is formed on the second end of the base plate 21, opposite to the end wall 23, and is adjacent to the opening 212. Two opposite first latching portions 24, two opposite second latching portions 25, and two opposite third latching portions 26 are formed on the two opposite sidewalls 22. Each first latching portion 24 is adjacent to the end wall 23 and has a first extending portion 241 and a second extending portion 242. The first extending portion 241 and the second extending portion 242 are integral. The first extending portion 241 is thicker than the second extending portion 242 and is similar to the third latching portions 26. The first extending portions 241 of the first latching portions 24 and the two third latching portions 26 latch the connector 30 along a first direction X. The second extending portions 242 are about as thick as the second latching portions 25. The second extending portions 242 of the first latching portions 24 and the second latching portions 25 latch the connector 30 along a second direction Y. A latching groove 252 is defined between each second extending portion 242 and each second latching portion 25. The two third latching portions 26 are formed at one end of the two sidewalls 22 adjacent to the opening 212. Two resisting portions 27 are formed on the end wall 23 for abutting against the connector 30. A column 28 is formed on each sidewall 22 adjacent to a corresponding third latching portion 26 for positioning the PCB 40.

The connector 30 includes an insulating body 31 and a plurality of elastic metal fingers 32 embedded in the insulating body 31. The metal fingers 32 electronically connect the connecter 30 to the PCB and elastically support the PCB on the connector. The insulating body 31 has two opposite first surfaces 311 and two opposite second surfaces 312. Each first surface 311 forms a protrusion 33 to be received in the latching groove 252. Each protrusion 33 has a guiding edge. One of the second surfaces 312 defines a connecting hole 313. The PCB 40 defines at least two latching grooves 41 for engaging with the columns 28.

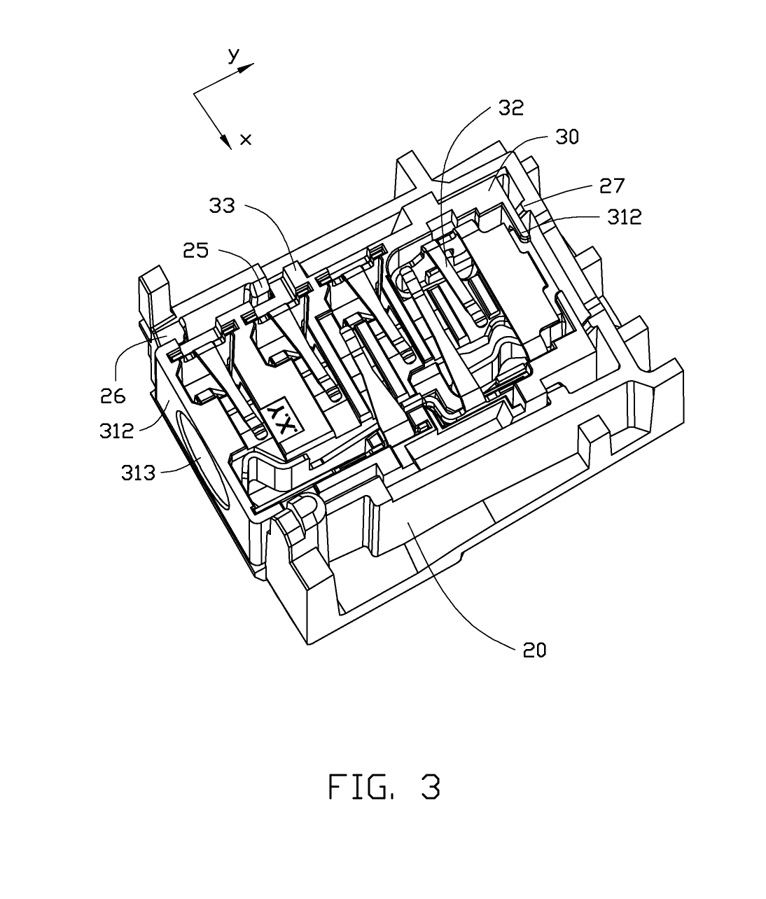

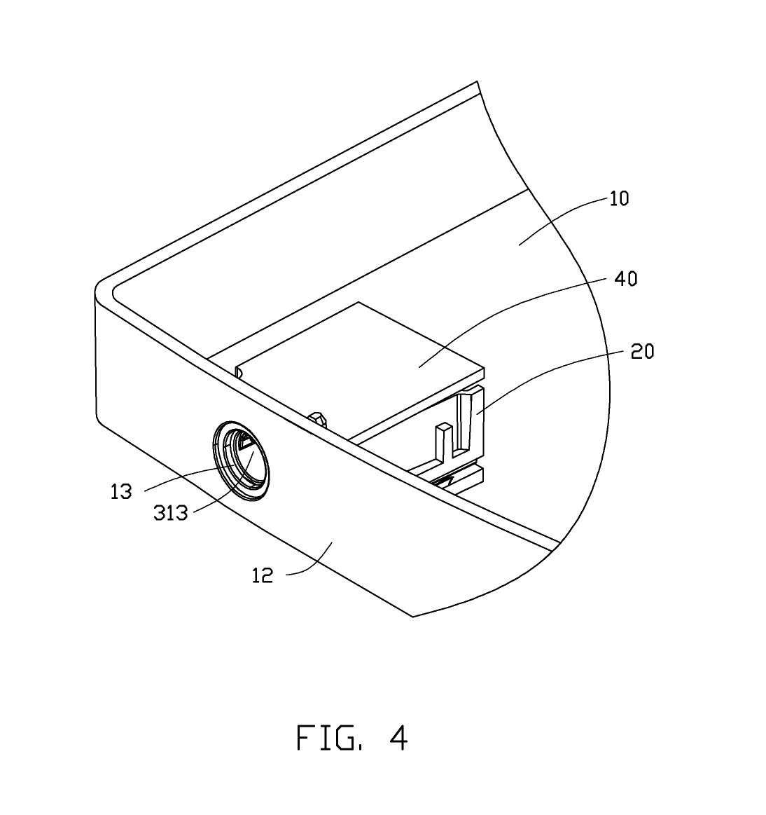

In assembly, referring to FIGS. 3 and 4, the connector 30 is positioned in the receiving portion 20, and the connecting hole 313 faces the opening 212. The first extending portions 241 of the first latching portions 24 and the two third latching portions 26 latch the connector 30 along the first direction X, and the second extending portions 242 of the first latching portions 24 and the second latching portions 25 latch the connector 30 along the second direction Y. The protrusions 33 of the connector 30 are received in the latching grooves 252. Finally, the second housing 15 is mounted in the first housing 10, and the connecting hole 313 is aligned with the through hole 13. The cushion portion 211 abuts against the side plate 12 of the first housing 10. The PCB 40 lays on top of the connector 30, and the columns 28 latch into the latching grooves 41. Thus, the assembly process of the positioning structure 200 is completed.

The present disclosure provides a positioning structure for stably securing the AV jack in the electronic device 100. When the first housing 10 of the electronic device 100 is impacted by an external force, the cushion 211 helps to buffer the impact and prevents the connector 30 from being damaged.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A positioning structure for an audio video (AV) jack, the positioning structure comprising:
a receiving portion comprising a base plate, two opposite sidewalls, and an end wall; the two opposite sidewalls comprising two opposite first latching portions, two opposite second latching portions, and two opposite third latching portions; each first latching portion comprises a first extending portion and a second extending portion; and a latching groove is defined between each second extending portion and each second latching portion; and
a connector comprising an insulating body and a plurality of elastic metal fingers, and the insulating body comprises two protrusions received in the latching grooves;
wherein the first extending portions and the two third latching portions latch the insulating body of the connector in a first direction, and the second extending portions of the first latching portions and the second latching portions latch the insulating body of the connector in a second direction.

2. The positioning structure as claimed in claim 1, wherein an opening is defined between the two opposite sidewalls opposite to the end wall, and a cushion portion is located on one end of the base plate, opposite to the end wall and adjacent to the opening.

3. The positioning structure as claimed in claim 2, wherein the first extending portion is thicker than the second extending portion and has the same thickness as the third latching portions, and the second extending portions are about as thick as the second latching portions.

4. The positioning structure as claimed in claim 3, wherein the two third latching portions are formed at ends of the two opposite sidewalls, and the end wall has two resisting portions for abutting against the connector.

5. The positioning structure as claimed in claim 4, wherein a column is located at each of the two opposite sidewalls, adjacent to a corresponding third latching portion.

6. An electronic device, comprising:
a first housing comprising a side plate;
a second housing engaging with the first housing, the second housing comprising a receiving portion, the receiving portion comprises a base plate, two opposite sidewalls, and an end wall; an opening is defined between the two sidewalls opposite to the end wall, the opening faces the side plate;
a connector comprising an insulating body and a plurality of elastic metal fingers;
the insulating body positioned among the base plate, the two opposite sidewalls and the end wall; and
a printed circuit board electronically the connector.

7. The electronic device as claimed in claim 6, wherein a cushion portion is located on one end of the base plate, opposite to the end wall and adjacent to the opening.

8. The electronic device as claimed in claim 6, wherein the two opposite sidewalls comprise two opposite first latching portions, two opposite second latching portions, and two opposite third latching portions; and a latching groove is defined between each first latching portion and each second latching portion.

9. The electronic device as claimed in claim 8, wherein each first latching portion comprises a first extending portion and a second extending portion, the first extending portion is thicker than the second extending portion and has the same thickness as the third latching portions, and the second extending portions are about as thick as the second latching portions.

10. The electronic device as claimed in claim 8, wherein the two third latching portions are located at ends of the two opposite sidewalls, the end wall has two resisting portions for abutting against the connector.
